(19) United States
(12) Patent Application Publication
(10) Pub. No.: US 2022/0193950 A1
(43) Pub. Date: Jun. 23, 2022

(54) TILE CUTTER WITH WATER CONTROL ASSEMBLY

(71) Applicant: REXON INDUSTRIAL CORP., LTD., Taichung (TW)

(72) Inventor: WAN JIE YOU, Taichung (TW)

(73) Assignee: REXON INDUSTRIAL CORP., LTD., Taichung (TW)

(21) Appl. No.: 17/561,096

(22) Filed: Dec. 23, 2021

(30) Foreign Application Priority Data
Dec. 23, 2020 (TW) 109145784

(51) Int. Cl. B28D 1/04; B28D 7/04; B28D 7/02

(52) U.S. Cl. CPC B28D 1/041; B28D 7/02; B28D 7/04

(57) ABSTRACT

A tile cutter with water control assembly includes a base, a work platform slidably set on the base along a front-rear direction, a sawing device including a saw blade seat installed in the base and a saw blade installed in the saw blade seat oriented for cutting along the front-rear direction, and a water control assembly including a body unit arranged on the saw blade seat and defining a water inlet and an accommodating space communicating with the water inlet, a water outlet unit arranged on the body unit and communicating with the accommodating space, and a body unit arranged at a first control unit of the body unit. An inlet water flow enters the accommodating space through the water inlet, and then flows out through the water outlet unit to form an outlet water flow spraying on the saw blade. The first control unit is used to regulate one of the size and position of the outlet water flow.

### BACKGROUND OF THE INVENTION

### 1. Field of the Invention

The present invention relates to a cutting machine, in particular to a tile cutter with a water control assembly.

### 2. Description of the Related Art

An existing tile cutter is suitable for cutting a tile, and includes a base, a work platform, and a sawing device. The work platform is used for placing the tiles and moving towards the sawing device. The sawing device has a saw blade seat set on the base and a saw blade set on the saw blade seat. When the existing tile cutter cuts the tiles, it is usually used with a water supply device. The water supply device has a water pump and a water outlet device connected to the water pump and adjacent to the saw blade. The water outlet device sprays cooling water on the saw blade and the tile, in addition to cooling the saw blade, it can also moisten the dust generated during cutting to prevent the dust from flying freely.

However, when the water supply device is used in conjunction with the existing tile cutter, it can only adjust the size of the water supply and the position of the water flow by adjusting the water pumping pump. Since the water pumping pump is mostly set close to the water source and far away from the existing tile cutter, it is impossible to adjust the size or position of the water flow in real time according to the use needs, resulting in inconvenient use.

### SUMMARY OF THE INVENTION

The present invention has been accomplished under the circumstances in view. It is the main object of the present to provide a tile cutter with water control assembly that can adjust the size or position of the water flow nearby and instantly to improve the convenience of use.

Therefore, the tile cutter with water control assembly of the present invention is suitable for cutting a tile, and comprises a base, a work platform, a sawing device, and a water control assembly. The base extends along a front-rear direction. The work platform is slidably installed on the base along the front-rear direction, and used for placing the tile. The sawing device comprises a mounting arm set above the base, a saw blade seat set on the mounting arm and located on a front side of the work platform, and a saw blade set on the saw blade seat oriented for cutting along the front-rear direction. The water control assembly comprises a body unit installed on the saw blade seat and on one side of the saw blade away from the mounting arm, a water outlet unit pivotally installed on the body unit and adjacent to the saw blade, and a first control unit set in the body unit. The body unit defines a water inlet, and an accommodating space connecting the water inlet and the water outlet unit. An inlet water flow enters the accommodating space through the water inlet, and then flows out through the water outlet unit to form an outlet water flow spraying on the saw blade. The first control unit is used to regulate one of the size of the outlet water flow and the position of the outlet water flow.

The effect of the present invention is: By setting the water control assembly on the saw blade seat, and the water control assembly comprising the first control unit for adjusting one of the size of the outlet water flow and the position of the outlet water flow, the user can instantly and conveniently adjust the size and position of the outlet water flow.

Other advantages and features of the present invention will be fully understood by reference to the following specification in conjunction with the accompanying drawings.

### BRIEF DESCRIPTION OF THE DRAWINGS

FIG. 1 is an elevational view of an embodiment of the tile cutter with water control assembly of the present invention.

FIG. 2 is a partial right side view of this embodiment, and a cover plate is omitted in the figure to show a water control assembly and a sawing device.

FIG. 3 is a partial left view of the embodiment.

FIG. 4 is an elevational view of the water control assembly of the embodiment.

FIG. 5 is an exploded view of the water control assembly of the embodiment.

FIG. 6 is a cross-sectional view of the water control assembly, showing a maximum water flow position of a first adjustment control relative to the device body.

FIG. 7 is a view similar to FIG. 6, showing the first adjustment control at a minimum water flow position relative to the device body.

### DETAILED DESCRIPTION OF THE INVENTION

The present invention will be described in detail below with reference to the drawings and embodiments. Before the present invention is described in detail, attention should be paid to the relative position terms used in the following descriptions, for example, “front-rear direction X”, “left-right direction Y”, “top-bottom direction Z” are based on the orientation shown in each drawing and the normal use orientation, the front-rear direction X, the left-right direction Y, and the top-bottom direction Z are perpendicular to each other.

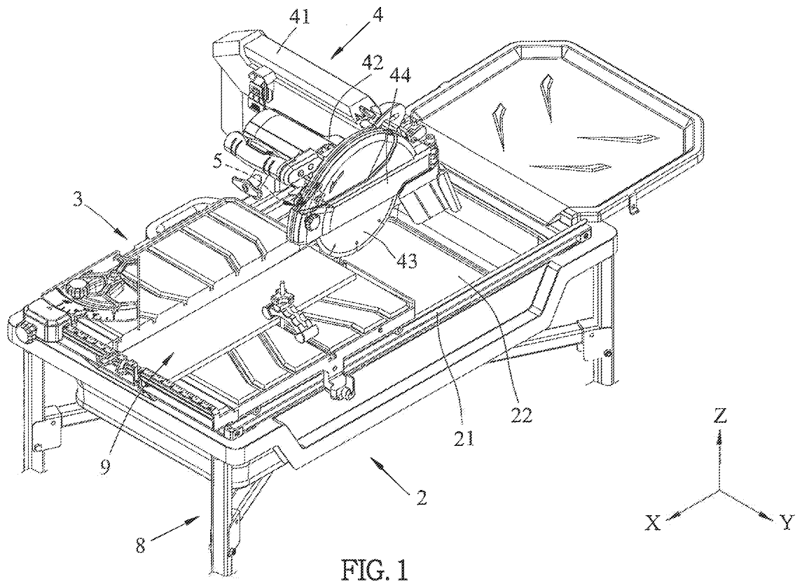

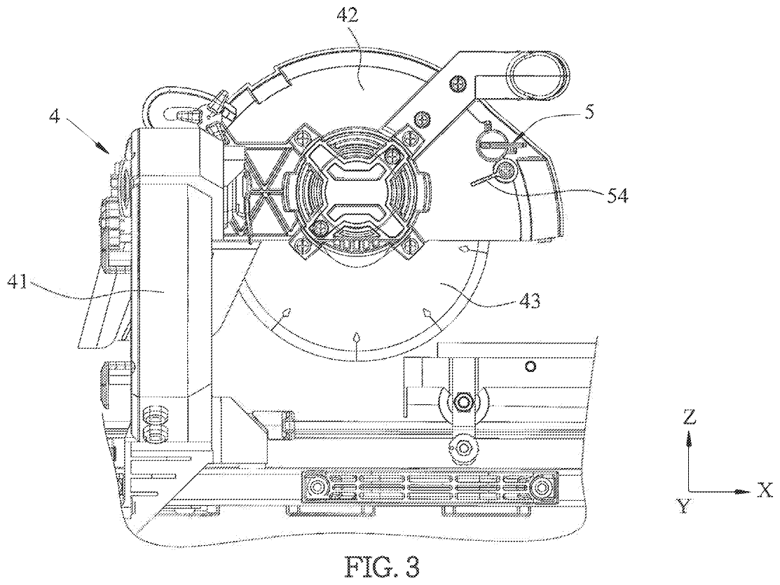

Referring to FIGS. 1-3, an embodiment of the tile cutter with water control assembly of the present invention is suitable for cutting a tile 9, and comprises a base 2, a work platform 3, a sawing device 4, and a water control assembly 5.

The base 2 extends along a front-back direction X, and is used for erection and fixing on a stand 8 or a worktable (not shown). The base 2 comprises two sliding rails 21 arranged at intervals along the left-right direction Y and parallel to each other, and a water collection tank 22 located between the sliding rails 21. In this embodiment, the base 2 is erected and fixed on the stand 8.

The work platform 3 can be slidably arranged on the sliding rails 21 along the front-rear direction X, and used for placing the tile 9.

The sawing device 4 is arranged on the front side of the work platform 3 along the front-rear direction X, and comprises a mounting arm 41 fixed above the base 2, a saw blade seat 42 mounted on the mounting arm 41 and located on the front side of the work platform 3, a saw blade 43 arranged on the saw blade seat 42 and oriented for cutting along the front-rear direction X and rotatable along its own axial direction, and a cover plate 44 that is pivotally connected to the saw blade seat 42 and can be opened or closed relative to the saw blade seat 42. In this embodiment, when the cover plate 44 is closed, the cover plate 44 is covered outside the right side of the saw blade 43.

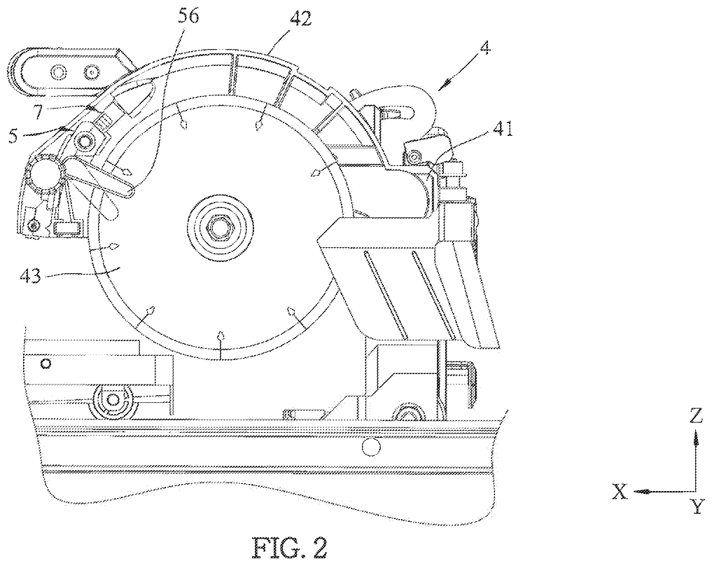

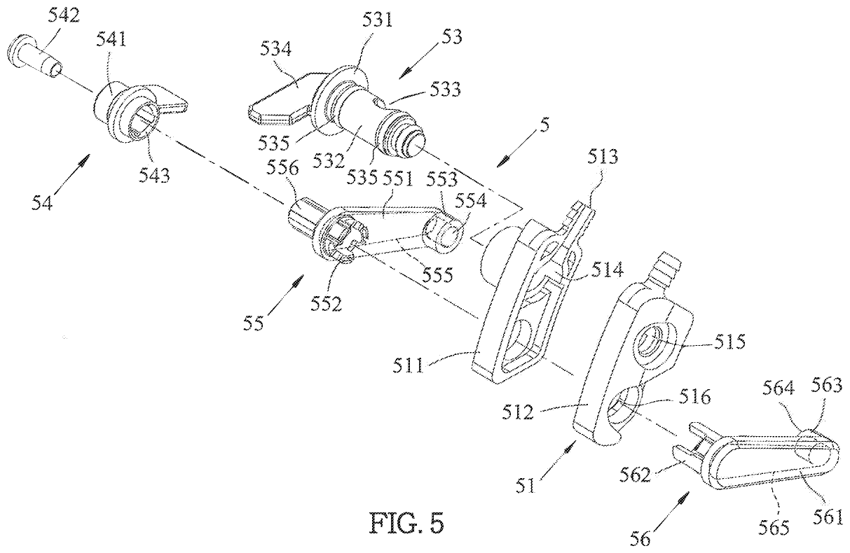

Referring to FIGS. 2, 4 and 5, the water control assembly 50 comprises a body unit 51, a water outlet unit 52, a first control unit 53, and a second control unit 54.

The body unit 51 is detachably arranged in the saw blade seat 42, and is located on the side of the saw blade 43 away from the mounting arm 41, that is, at the rear side of the saw blade 43. The body unit 51 comprises a left shell 511 and a right shell 512 that are connected to each other, a water inlet 513 jointly defined by the left shell 511 and the right shell 512, an accommodating space 514 connecting the water inlet 513 and the water outlet unit 52, and a first perforation 515 and a second perforation 516 connecting the accommodating space 514.

The water outlet unit 52 is pivotally disposed on the body unit 51 and adjacent to the saw blade 43, and comprises a left water outlet device 55 arranged on the left shell 511 and a right water outlet device 56 arranged on the right shell 512.

The left water outlet device 55 and the right water outlet device 56 are placed in the second perforation 516 and connected to each other.

The left water outlet device 55 comprises a left-handed arm 551 located outside the left shell 511, a left connecting portion 552 that is arranged at the rear end of the left-handed arm 551 and penetrates the second perforation 516 and extends into the accommodating space 514, a left water outlet portion 553 provided at the front end of the left-handed arm 551 and on the left side of the saw blade 43, a left water outlet 554 provided at the left water outlet portion 553, a left water outlet channel 555 arranged on the left-handed arm 551 and connected with the left water outlet 554 and the accommodating space 514, and a bolt tooth column 556 arranged at the rear end of the left-handed arm 551.

The right water outlet device 56 comprises a right-handed arm 561 located outside the right shell 512, a right connecting portion 562 which is arranged at the rear end of the right-handed arm 561 and penetrates the second perforation 516 and extends into the accommodating space 514 and is coupled to the left connecting portion 552, a right water outlet portion 563 located at the front end of the right-handed arm 561 and on the right side of the saw blade 43, a right water outlet 564 located on the right water outlet portion 563, and a right water outlet channel 565 arranged on the right-handed arm 561 and connected with the right water outlet 563 and the accommodating space 516.

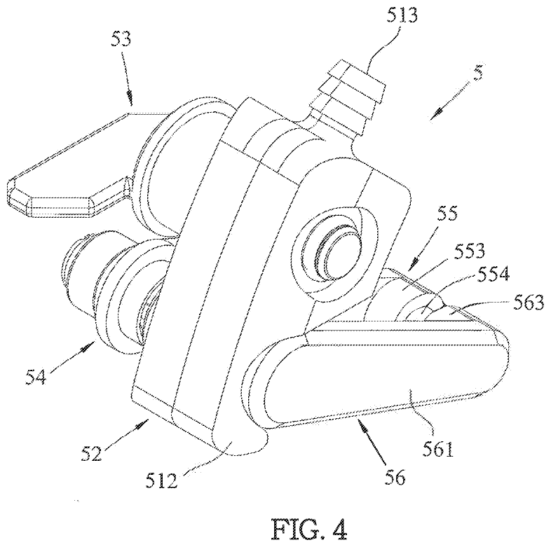

Referring to FIGS. 4-6, the first control unit 53 comprises a flow control device 531 arranged in the body unit 51. The flow control device 531 comprises a blocking portion 532 that penetrates the first perforation 515 and is located in the accommodating space 514, a flow portion 533 recessed in the blocking portion 532 and aligned with the water inlet 513, and a flow regulating knob 534 connected to the blocking portion 532 and located outside the body unit 51.

The first control unit 53 also comprises a gasket 535 sleeved on the first blocking portion 532 and located in the first perforation 515, which has the function of preventing water leakage.

The second control unit 54 comprises a position adjustment control 541 connected to the left water outlet device 55. The position adjustment control 541 comprises a bolt tooth sleeve 543 that is sleeved and connected to the bolt tooth column 556. By operating the position adjustment control 541, the left water outlet device 55 and the right water outlet device 56 can be driven to rotate relative to the body unit 51, so that the positions of the left water outlet 554 and the right water outlet 564 relative to the saw blade 43 can be adjusted.

Referring to FIGS. 2 and 4-6, when in use, a water pipe 7 can be connected to the water inlet 513 of the body unit 51 to facilitate the injection of a cooling water into the water control assembly 5. When an inlet water flow 100 flows into the accommodating space 514 through the water inlet 513, and is divided into the left water outlet channel 555 and the right water outlet channel 565, it can flow out through the left water outlet 554 and the right water outlet 564 and form an outlet water flow 200 for spraying on the saw blade 43.

In this embodiment, the first control unit 53 is configured to regulate the size of the outlet water flow 200, and the second control unit 54 is configured to regulate the position of the outlet water flow 200.

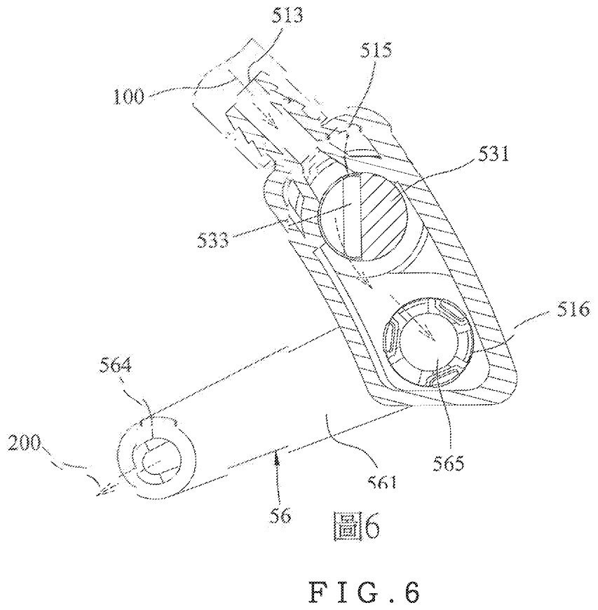

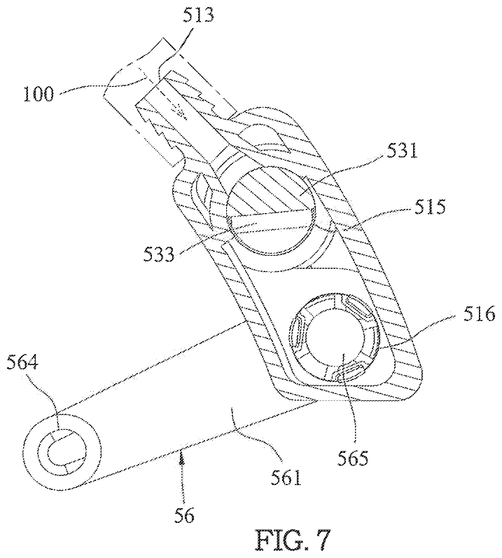

Referring to FIGS. 6 and 7, to adjust the size of the outlet water flow 200, the flow regulating knob 534 can be turned to make the flow control device 531 rotate between a maximum water flow position and a minimum water flow position relative to the body unit 51. At the maximum water flow position, the flow portion 533 is aligned with the water inlet 513, so that the inlet water flow 100 can all flow into the accommodating space 514. In the minimum water flow position, the blocking portion 532 is aligned with the water inlet 513, which can block the inlet water flow 100 to reduce the amount of water flowing into the accommodating space 514. In practice, the flow control device 531 can stay at any position between the maximum water flow position and the minimum water flow position according to the required water flow size.

Referring to FIGS. 2-5, to adjust the position of the outlet water flow 200, the position adjustment control 541 can be rotated to drive the left water outlet device 55 and the right water outlet device 56 to rotate relative to the body unit 51, and the position of the left water outlet 554 and the right water outlet 564 can be adjusted relative to the saw blade 43.

In summary, the tile cutter with water control assembly of the present invention, by arranging the water control assembly 5 in the saw blade seat 42, allows the user to adjust the outlet water flow 200 immediately and conveniently when operating the tile cutter, thereby improving the convenience of use. By rotating the flow regulating knob 534, the water control assembly 5 can rotate the flow control device 531 relative to the body unit 51 between a maximum water flow position and a minimum water flow position, thereby adjusting the size of the outlet water flow 200. By operating the position adjustment control 541, the left water outlet device 55 and the right water outlet device 56 can be driven to rotate relative to the body unit 51, and the position of the outlet water flow 200 relative to the saw blade 43 can be adjusted. It can achieve the purpose of the invention.

It is worth noting that the present invention only needs to set one of the first control unit 53 and the second control unit 54 to have the effect of adjusting the size or position of the outlet water flow 200. Of course, setting the first control unit 53 and the second control unit 54 at the same time also has the effect of adjusting the size and position of the outlet water flow 200.

However, the above are only examples of the present invention, and should not be used to limit the scope of implementation of the present invention. All simple equivalent changes and modifications made according to the scope of the patent application of the present invention and the content of the patent specification are still within the scope of the patent of the present invention.

What is claimed is:

1. A tile cutter with water control assembly, suitable for cutting a tile, comprising:
a base extending along a front-rear direction;
a work platform slidably installed on said base along said front-rear direction and used for placing said tile;
a sawing device comprising a mounting arm set above said base, a saw blade seat set on said mounting arm and located on a front side of said work platform, and a saw blade set on said saw blade seat oriented for cutting along said front-rear direction; and
a water control assembly comprising a body unit installed on said saw blade seat and on one side of said saw blade away from said mounting arm, a water outlet unit pivotally installed on said body unit and adjacent to said saw blade, and a first control unit set in said body unit, said body unit defining a water inlet and an accommodating space connecting said water inlet and said water outlet unit;
wherein: an inlet water flow enters said accommodating space through said water inlet, and then flows out through said water outlet unit to form an outlet water flow spraying on said saw blade; said first control unit being configured to regulate one of the size of said outlet water flow and the position of said outlet water flow.

2. The tile cutter with water control assembly as claimed in claim 1, wherein said water control assembly further comprises a second control unit disposed in said body unit, and said second control unit being configured to regulate an other of the size of said outlet water flow and the position of said outlet water flow.

3. The tile cutter with water control assembly as claimed in claim 2, wherein said body unit comprises a left shell and a right shell docked with each other, said left shell and said right shell jointly defining said water inlet and said accommodating space, and a first perforation and a second perforation connecting said accommodating space.

4. The tile cutter with water control assembly as claimed in claim 3, wherein said water outlet unit comprises a left water outlet device set in said left shell, and a right water outlet device set in said right shell, said left water outlet device and said right water outlet device being placed in said second perforation and connected to each other, said left water outlet device comprising a left water outlet on a left side of said saw blade, said right water outlet device comprising a right water outlet on an opposing right side of said saw blade.

5. The tile cutter with water control assembly as claimed in claim 4, wherein one of said first control unit and said second control unit used to adjust the size of said outlet water flow comprises a flow control device set in said body unit, said flow control device being rotatable between a maximum water flow position and a minimum water flow position relative to said body unit.

6. The tile cutter with water control assembly as claimed in claim 5, wherein said flow control device comprises a blocking portion passing through said first perforation and located in said accommodating space, a flow portion recessed in said blocking portion and aligned with said water inlet, and a flow regulating knob connected to said blocking portion and located outside said body unit.

7. The tile cutter with water control assembly as claimed in claim 6, wherein one of said first control unit and said second control unit configured to adjust the position of said outlet water flow comprises a position adjustment control connected to said left water outlet device, said position adjustment control being operable to rotate said left water outlet device and said right water outlet device relative to said body unit to further adjust the positions of said left water outlet and said right water outlet relative to said saw blade.

8. The tile cutter with water control assembly as claimed in claim 7, wherein said left water outlet device comprises a left-handed arm located outside said left shell, a left connecting portion arranged at a rear end of said left-handed arm and penetrating said second perforation and extending into said accommodating space, a left water outlet portion provided at an opposing front end of said left-handed arm and on the left side of said saw blade, a left water outlet provided at said left water outlet portion, and a left water outlet channel arranged on said left-handed arm and connected with said left water outlet and said accommodating space; said right water outlet device comprises a right-handed arm located outside said right shell, a right connecting portion arranged at a rear end of said right-handed arm and penetrating second perforation and extending into said accommodating space and coupled to said left connecting portion, a right water outlet portion located at an opposing front end of said right-handed arm and on the right side of said saw blade, a right water outlet located on said right water outlet portion, and a right water outlet channel arranged on said right-handed arm and connected with said right water outlet and said accommodating space.

9. The tile cutter with water control assembly as claimed in claim 8, wherein said left water outlet device further comprises a bolt tooth column arranged at the rear end of said left-handed arm; said position adjustment control comprises a bolt tooth sleeve sleeved on and connected with said bolt tooth column.

10. The tile cutter with water control assembly as claimed in claim 9, wherein said sawing device further comprises a cover plate set on said saw blade seat and openable on the right side of said saw blade.
